(19) United States
(12) Patent Application Publication
(10) Pub. No.: US 2026/0178450 A1
(43) Pub. Date: Jun. 25, 2026

(54) ASSESSMENT OF POTENTIAL BACKUP REVERSION DATA LOSS

(71) Applicant: Dell Products L.P., Round Rock, TX (US)

(72) Inventors: Tejas Anil Vaykole, Pune (IN); Narayan Behera, Pune (IN); Sameer P. Mohod, Pune (IN)

(21) Appl. No.: 18/988,443

(22) Filed: Dec. 19, 2024

(51) Int. Cl. G06F 11/14

(52) U.S. Cl. CPC G06F 11/1469; G06F 2201/80

(57) ABSTRACT

Responsive to a request to revert a version of a file corresponding to a current snapshot to a version of the file corresponding to a previous snapshot, a computing system may determine at least one storage block that may correspond to data associated with at least one other file that may be lost by reverting a file set comprising the file to the previous snapshot. Files corresponding to the determined storage block(s) may be indicated to a user of the computing system. To avoid losing a current version of the at least one other file, the computing system may generate a modified snapshot that corresponds to a desired version, associated with a previous snapshot, of the file to be reverted and that corresponds to a current version of the at least one other file. The computing system may facilitate reverting the file set to versions corresponding to the modified snapshot.

### REFERENCE TO RELATED APPLICATION

The subject patent application is related to U.S. patent application Ser. No. ______, filed ______, and entitled “Partial snapshot data block reversion” (docket no. 141062.01/DELLP1402US), the entirety of which application is hereby incorporated by reference herein.

### BACKGROUND

A cloud computing service provider may make various computing resources, for example, software as a service, virtual machines, storage, bare metal computing hardware, or even a complete enterprise's infrastructure and development platforms, available over a communication network. A cloud services provider may make a public cloud computing resource available to users over a publicly accessible network, such as the Internet. A private cloud computing resource is typically available or accessible only by a given customer, such as an enterprise and its employees. Computing resources may be provided from an enterprise's own on-premises data center or from a data center operated by an independent (e.g., independent from the enterprise customer) cloud services provider. A hybrid cloud may connect an organization's private cloud services and resources of public clouds into an infrastructure that facilitates the organization's applications and workloads in a manner that balances the maximizing of performance and the minimizing of costs.

Cloud providers, whether public or private, may use clustering of servers. A server cluster typically comprises servers that share a single Internet Protocol (“IP”) address. Clustering enhances data protection typically, availability, load balancing, and scalability. A server associated with a cluster may be referred to as a node, which may comprise storage components, random access memory (“RAM”), and central processing unit (“CPU”) resources.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise receiving, by at least one computing system comprising at least one processor, at least one reversion request to facilitate at least one reversion action with respect to at least one current version of at least one computing resource to at least one previous version of the at least one computing resource. Responsive to the at least one reversion request, the method may further comprise determining, by the at least one computing system, at least one of the at least one computing resource corresponding to the at least one current version of the at least one computing resource that differs with respect to the at least one previous version of the at least one computing resource to result in at least one determined different computing resource. Based on the at least one determined different computing resource, the method may further comprise facilitating, by the at least one computing system, communicating at least one reversion indication indicative of the at least one computing resource.

In an example embodiment, the at least one computing resource may comprise at least one storage unit. The at least one determined different computing resource may comprise at least one determined different storage unit. The at least one storage unit may comprise at least of: at least one file, at least one folder, or at least one volume. The at least one determined different storage unit may comprise at least one determined different storage block.

In an example embodiment, the determining of the at least one determined different computing resource may comprise determining at least one file corresponding to the at least one determined different storage block to result in at least one determined file. The at least one reversion indication may be indicative of the at least one determined file.

The at least one reversion indication may be indicative that the at least one current version of the at least one determined file is threshold likely to be lost in response to the at least one current version of the at least one determined file being reverted to the at least one previous version of the at least one determined file. For example, the at least one reversion indication may be indicative that the at least one current version of the at least one determined files will be lost, even if the at least one determined file to be reverted to the at least one previous version is ultimately recoverable or restorable.

In an example embodiment, the at least one determined different computing resource may be determined within a kernel space of a memory corresponding to the at least one computing system.

In an example embodiment, the determining of the at least one determined different computing resource may comprise determining, in a reverse temporal order with respect to which the at least one current version of the at least one computing resource and the at least one previous version of the at least one computing resource were created, at least one intervening version of the at least one computing resource.

In an example embodiment, at least one of the at least one current version of the at least one computing resource, at least one intervening version of the at least one computing resource, or the at least one previous version of the at least one computing resource may correspond to at least one snapshot. The at least one determined different computing resource may be associated with metadata that corresponds to the at least one current version of the at least one computing resource, the at least one intervening version of the at least one computing resource, or the at least one previous version of the at least one computing resource. The at least one determined different computing resource may be based on the at least one current version of the at least one computing resource, the at least one intervening version of the at least one computing resource, or the at least one previous version of the at least one computing resource.

In another example embodiment, a computing system may comprise at least one processor configured to process executable instructions that, when executed by the at least one processor, may facilitate performance of operations that may comprise receiving at least one reversion query request that requests reversion information associated with performing a reversion action with respect to at least one current version of at least one computing resource to at least one previous version of the at least one computing resource. Responsive to the at least one reversion query request, the operations may further comprise determining at least one of the at least one computing resource corresponding to the at least one current version of the at least one computing resource that differs with respect to the at least one previous version of the at least one computing resource to result in at least one determined different computing resource. Based on the at least one determined different computing resource, the operations may further comprise generating at least one reversion information indication indicative of the reversion information. The at least one reversion information indication may be indicated to a user via a user interface or to at least one component or element of another computing system.

In an example embodiment, the at least one previous version of the at least one computing resource may comprise at least one earliest version and at least one intermediate version. The at least one earliest version may correspond to at least one earliest time. The at least one current version of the at least one computing resource may correspond to at least one current time. The at least one intermediate version may correspond to at least one intermediate time that is later than the at least one earliest time and earlier than the at least one current time. The reversion information may correspond to at least one of the at least one earliest version or at least one of the at least one intermediate version.

In an example embodiment, responsive to the at least one reversion information indication, the operations may further comprise receiving at least one reversion request to facilitate a reversion action with respect to the at least one current version of at least one computing resource to at least one of the at least one previous version of the at least one computing resource.

The at least one computing resource may comprise at least one file. The at least one reversion information indication may be indicative of at least one change to at least one storage block corresponding to the at least one computing resource to be caused by the reversion action.

In yet another example embodiment, a non-transitory machine-readable medium may comprise executable instructions that, when executed by at least one processor of a computing system, may facilitate performance of operations that may comprise, responsive to at least one reversion request indicative of a first snapshot, corresponding to a first version of at least one computing resource and that is an earlier snapshot than a second snapshot corresponding to a second version of the at least one computing resource, determining at least one first resource corresponding to the first version of the at least one computing resource that differs with respect at least one second resource corresponding to the second version of the at least one computing resource to result in at least one determined different computing resource. Based on the at least one determined different computing resource, the operations may further comprise communicating at least one reversion information indication indicative of the at least one determined different computing resource.

In an example embodiment, the at least one reversion information indication may be indicative of stored information stored in at least one storage unit corresponding to the second snapshot to be lost as a result of the second version of the at least one computing resource being reverted to the first version of the at least one computing resource.

In an example embodiment, the at least one reversion information indication may be indicative of at least one file corresponding to the second version that differs with respect to the first version.

In an example embodiment, the at least one determined different computing resource may be determined based on first metadata corresponding to the first version and second metadata corresponding to the second version.

In another example embodiment, a method may comprise receiving, by at least one computing system comprising at least one processor, at least one revert request indicative of at least one reversion action to be performed to a current version of at least one computing resource with respect to at least one previous version of the at least one computing resource. Responsive to the at least one revert request, the method may further comprise determining, by the at least one computing system, at least one of the at least one computing resource corresponding to the current version of the at least one computing resource that differs with respect to the at least one previous version of the at least one computing resource to result in at least one determined different computing resource. The method may further comprise receiving, by the at least one computing system, at least one revert instruction to perform at least one reversion action with respect to the at least one computing resource. Responsive to the at least one revert instruction, the method may further comprise performing, by the at least one computing resource, the at least one reversion action.

In an example embodiment, the at least one revert request to perform the at least one reversion action may be determined based on the at least one determined different computing resource.

In an example embodiment, the method may further comprise determining, by the at least one computing system, at least one storage unit corresponding to the at least one determined different computing resource.

In an example embodiment, the at least one computing resource may comprise a first computing resource and a second computing resource. The at least one reversion action indicated by the at least one revert request may comprise reverting the first computing resource to a first previous version of the first computing resource and avoiding reverting the second computing resource to a second previous version of the second computing resource.

In an example embodiment, the first computing resource may comprise a first file and the second computing resource may comprise a second file. The current version of the at least one computing resource may comprise a first current version of the first file and a second current version of the second file. The at least one previous version of the at least one computing resource may comprise a first previous version of the first file and a second previous version of the second file. A current snapshot may comprise the first current version of the first file and the second current version of the second file. A previous snapshot may comprise the first previous version of the first file and the second previous version of the second file.

In an example embodiment, the reverting of the first computing resource to the first previous version of the first computing resource may comprise overwriting at least one current storage block corresponding to the first current version of the first file associated with the current snapshot with at least one pervious storage block corresponding to the first previous version of the first file associated with the previous snapshot.

In an example embodiment, the reverting of the first computing resource to the first previous version of the first computing resource may comprise deleting at least one first current storage block corresponding to the first current version of the first file associated with the current snapshot, and wherein the at least one first current storage block is nonexistent with respect to the first previous version of the first file associated with the previous snapshot.

In an example embodiment, the reverting of the first computing resource to the first previous version of the first computing resource may comprise restoring at least one non-used storage block that is not used with respect to the first current version of the first file associated with the current snapshot. The at least one non-used storage block that is not used with respect to the first current version of the first file associated with the current snapshot may be used with respect to the first previous version of the first file associated with the previous snapshot.

In an example embodiment, a result of the reverting of the first computing resource to the first previous version of the first computing resource and the avoiding of the reverting the second computing resource to the second previous version of the second computing resource may be a modified previous snapshot. The example method may further comprise updating, by the at least one computing system, first metadata corresponding to the first computing resource to reflect the reverting the first computing resource to a first previous version of the first computing resource to result in updated first metadata and avoiding, by at least one computing system, changing second metadata corresponding to the second computing resource to result in unchanged second metadata. The updated first metadata and the unchanged second metadata may be associated with the modified previous snapshot.

In another example embodiment, a computing system may comprise at least one processor configured to process executable instructions that, when executed by the at least one processor, may facilitate performance of operations that may comprise, responsive to at least one revert request indicative of at least one reversion action to be performed to a current version of at least one computing resource corresponding to a current snapshot with respect to a previous version of the at least one computing resource corresponding to a previous snapshot, determining at least one of the at least one computing resource corresponding to the current version of the at least one computing resource that differs with respect to the previous version of the at least one computing resource to result in at least one determined different computing resource. Responsive to at least one revert instruction to perform at least one reversion action with respect to the at least one computing resource, the operations may further comprise performing the at least one reversion action.

In an example embodiment, the at least one determined different computing resource may comprise a first determined different computing resource and a second determined different computing resource. The at least one revert instruction may comprise a first revert instruction and a second revert instruction. The first revert instruction may be indicative to revert the first determined different computing resource to a first previous version corresponding to the previous snapshot. The second revert instruction may be indicative that reverting the second determined different computing resource to a second previous version corresponding to the previous snapshot is to be avoided. A result of the performing of the at least one reversion action may be a modified previous snapshot that comprises the first previous version of the first determined different resource corresponding to the previous snapshot and the second determined different computing resource corresponding to the current snapshot.

In an example embodiment, the at least one determined different computing resource may comprise an intermediate determined different computing resource corresponding to an intermediate snapshot that is temporally intermediate with respect to the previous snapshot and the current snapshot, wherein the current snapshot comprises the intermediate determined different computing resource, wherein the previous snapshot does not comprise the intermediate determined different computing resource, and wherein the modified previous snapshot comprises the intermediate determined different computing resource. In an embodiment, the modified previous snapshot comprises a previous version, with respect to the current version of the intermediate determined different computing resource, of the intermediate determined different computing resource

In yet another example embodiment, a non-transitory machine-readable medium may comprise executable instructions that, when executed by at least one processor of a computing system, may facilitate performance of operations that may comprise, responsive to at least one revert request corresponding to at least one reversion action to be performed with respect to a current snapshot, determining at least one computing resource corresponding to the current snapshot that differs with respect to at least one previous snapshot to result in at least one determined different computing resource. Responsive to at least one revert instruction, associated with the at least one revert request, to perform at least one reversion action with respect to the current snapshot, and based on the at least one determined different computing resource, the operations may further comprise performing the at least one reversion action to result in at least one modified snapshot.

In an example embodiment, the at least one previous snapshot may correspond to at least one previous time. The at least one previous time may be earlier than a current time corresponding to the current snapshot. The current snapshot may correspond to a current version of a first file and a deleted version of a second file. The at least one previous snapshot may comprise at least one undeleted version of the second file and may not comprise the first file. The at least one reversion action may comprise reverting the deleted version of the second file to the at least one undeleted version of the second file and avoiding reverting the current version of the first file to result in the at least one modified previous snapshot comprising the at least one undeleted version of the second file and the current version of the first file.

In an example embodiment, the at least one previous snapshot may comprise a first previous snapshot corresponding to a first previous time and a second previous snapshot corresponding to a second previous time. The first previous time may be earlier than the second previous time. The current snapshot may correspond to a current version of a first file, a deleted version of a second file, and an original version of a third file. The second previous snapshot may correspond to the deleted version of the second file and the current version of the first file. The first previous snapshot may correspond to an undeleted version of the second file and an original version of the first file. The at least one reversion action may comprise reverting the second file from the deleted version of the second file to the undeleted version of the second file without reverting the first file to the original version of the first file to result in the at least one modified snapshot comprising the original version of the third file, the undeleted version of the second file, and the current version of the first file.

In an example embodiment, the at least one determined different computing resource may comprise at least one storage block. At least one modified snapshot may comprise at least one storage block corresponding to the at least one current snapshot and at least one storage block corresponding to the at least one previous snapshot.

### BRIEF DESCRIPTION OF THE DRAWINGS

FIG. 1 illustrates an example computing environment comprising multiple computing resource snapshots.

FIG. 2 illustrates example computing resource snapshot information.

FIG. 3 illustrates example computing resource changes that would result from performing at least one revert operation.

FIG. 4 illustrates a flow diagram of a method to provide assessment information corresponding to computing resource changes that would result from performing at least one revert operation.

FIG. 5 illustrates example computing resource computing information corresponding multiple snapshots and computing resources corresponding to a modified previous snapshot.

FIG. 6 illustrates a flow diagram of an example method to revert at least one computing resource corresponding to a current snapshot to a modified previous snapshot.

FIG. 7 illustrates a block diagram of an example method.

FIG. 8 illustrates a block diagram of an example computing system.

FIG. 9 illustrates a block diagram of an example non-transitory machine-readable medium.

FIG. 10 illustrates a block diagram of an example method.

FIG. 11 illustrates a block diagram of an example computing system.

FIG. 12 illustrates a block diagram of an example non-transitory machine-readable medium.

FIG. 13 illustrates a computer environment.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is only illustrative and exemplary of one or more concepts expressed by the various embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

A file system snapshot may correspond to a point in time and may represent a copy of a file system as the file system exists at the point in time. A snapshot may represent, or correspond to different, changed in data blocks with respect to a previous file system snapshot. A continuous snapshot scheme may generate and update snapshots of the file system at regular intervals, for example every second. If a series of snapshots of a file system exist and are available such that the file system can be reverted to a previous version of at least one computing resource, for example at least one file or at least one storage block that stores information associated with the at least one file, a user may rollback/revert a current version, or state, of a file to a previous version, or state, of the file. According to conventional techniques, a user may be presented with a list of at least one previous snapshot and at least one time associated with the at least one previous snapshot. The user may choose from the list of snapshots and revert the file back to a version/state of the file that may be determined by a computing system or selected by a user. However, a user may only need to rollback/revert fewer than all files corresponding to a particular snapshot, which may be a current snapshot, to an older version/state corresponding to a previous snapshot instead of reverting all files changed between the previous snapshot and the current snapshot. Thus, a problem exist according to conventional techniques that if a file is to be rolled back/reverted, from a current version/state of the file to a previous version/state of the file corresponding to a previous snapshot, some data, corresponding to a file other than a file with respect to which the reversion is desired that may also have changed from the time corresponding to the previous snapshot to the time corresponding to the current snapshot, may be lost by the rollback/reversion operation.

Accordingly, techniques disclosed herein solve problems related to loss of data that may exist with conventional techniques. Embodiments disclosed herein may facilitate providing a pre-reversion evaluation check that may facilitate providing to a user information corresponding to all files that may be modified or lost by performing snapshot reversion operation from one snapshot to another (e.g., reverting files from a current version/state corresponding to a current snapshot to a previous version/state corresponding to a previous snapshot). Thus, by providing a user with information indicative of file information corresponding to a current version/state of at least one file that may be changed or modified by performing a rollback/revert operation from a current snapshot to a previous snapshot, the user may make an informed assessment and decision regarding whether to implement a rollback/reversion from a current snapshot to a previous snapshot.

Furthermore, techniques disclosed herein solve problems existing with conventional techniques by facilitating rollback/reversion of selected files, or other selected computing resources, from a current version/state to a previous version/state corresponding to a current snapshot and a previous snapshot, respectively.

Embodiments disclosed herein may facilitate pre-reversion indication of potential data loss. By reporting possible data loss before a snapshot revert operation being instructed to be performed may facilitate a user in assessing the impact on current data versions if the snapshot revert operation is performed. By assessing indicated pre-reversion potential data loss that may result from performing a revert operation, the user may evaluate potential risks to data and may make an informed decision regarding whether to proceed with the revert operation or whether to explore alternative options with respect to recovering a previous version of a file. Thus, a user may determine, before a reversion action is performed, whether irreversible data changes would be made by performing the reversion action. Thus, embodiments disclosed herein may facilitate avoiding irreversible changes that could result in the loss of valuable data or configurations information.

Embodiments disclosed herein related to selective retention of file versions may facilitate flexibility and granular control over a snapshot revert process such that a user can manage and control the impact of the revert operation to a file system. Accordingly, a user may assess, before a revert operation, the effect of the revert operation and may selectively revert to different versions of different files, based on the pre-revert assessment, to result in desired versions of different files/computing resources, which may correspond to different previous snapshots, after the revert operation.

### Assessment of Potential Data Loss Corresponding to a Revert Operation

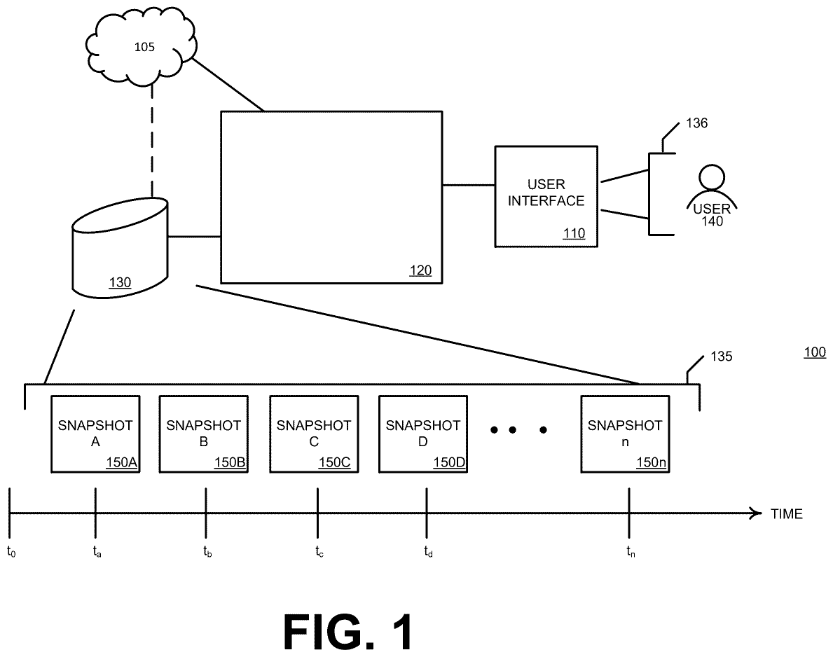

Turning now to the figures, FIG. 1 illustrates an example computing system environment 100. User interface 110 may be coupled to computing system 120, which may be connected to communication network 105 and storage device 130, storage equipment, or a component of a storage device. User 140 may use interface 110 to interact with the computing system. Storage device/component 130 may be coupled directly to communication network 105. Network 105 may comprise a private communication network, for example a local area network, or a public communication network, for example the Internet, World Wide Web, a long range wireless 5G network, a shortrange wireless network, such as, for example, Wi-Fi or Bluetooth, and the like. It will be appreciated that communication network 105 may be a wired network, a wireless network, or may comprise some wired network components and some wireless network components. Computing system 120 may generate, or cause to be generated, at least one snapshot 150 corresponding to at least one computing resource. For example, snapshot 150A may comprise information corresponding to, or indicative of, at least one computing resource corresponding to computing system 120 or corresponding to storage device/component 130 at time tₐ. For example, snapshot 150A may comprise information indicative of, or comprising, at least one file stored by storage component 130 at time tₐ. Similarly, snapshot 150B, snapshot 150C, snapshot 150D, and snapshot 150n may comprise computing resource information corresponding to, comprising, or respectively indicative of at least one computing resource respectively stored by storage component 130 at times t_{b}, t_{c}, t_{d}, or tₙ. Resource information indicated by a snapshot 150 may correspond to, or may be indicative of, storage blocks used by storage component 130 to store at least one file.

In an example, an example directory may comprise files having filenames file1.txt, file2.txt, file3.txt, file4.txt that may change versions between different snapshots of snapshot set 135. Storage component 130 may store files using storage blocks that each comprise, or use, 8 Kilo Bytes (“KB”) of the storage device/component. Snapshot A may be an initial snapshot taken at time tₐ. File 1.txt may have a last modified date of 2024 Jun. 9 (e.g., Jun. 6, 2024) and may comprise 10 KB, thus two storage blocks may be used by storage 130 to store file 1.txt; file 2.txt may have a last modified date of 2024 Jun. 8 and may comprise 15 KB, thus two storage blocks may be used by storage 130 to store file2.txt; file3.txt may have a last modified date of 2024 Jun. 7 and may comprise 20 KB, thus three storage blocks may be used by storage 130 to store file 3.txt; file 4.txt may have a last modified date of 2024 Jun. 6 and may comprise 25 KB, thus four storage blocks may be used by storage 130 to store file 4.txt. Thus, storage device/equipment/component 130 may use eleven storage blocks to store file1.text, file 2.txt, file 3.txt, and file 4.txt, which may comprise 70 KB.

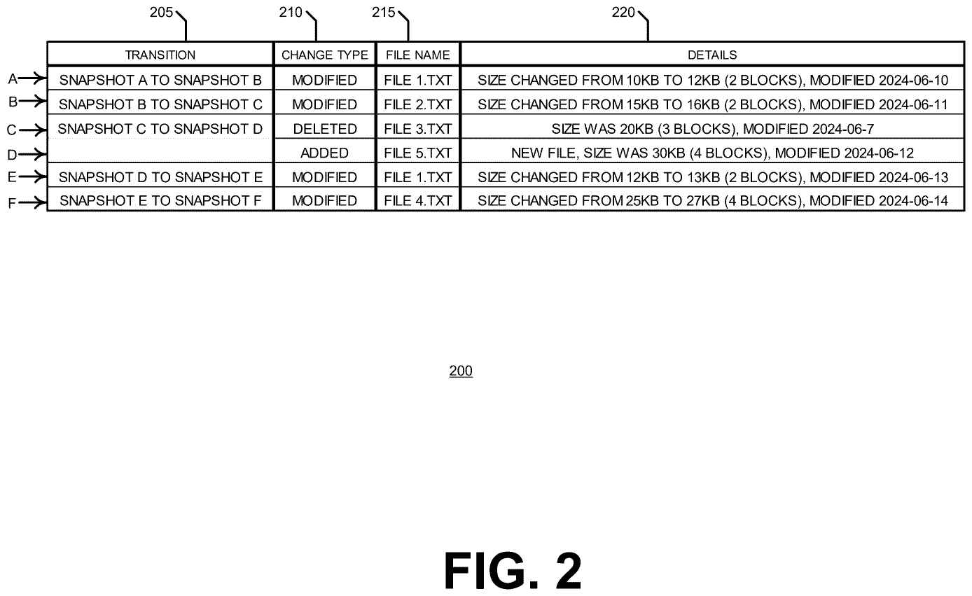

Continuing with the example, snapshot A may represent an initial version/state at time tₐ of files file1.txt, file2.txt, file3.txt, and file4.txt. Information, corresponding to snapshot B taken at time t_{b}, may comprise information indicative of a change to file1.txt that results in file 1.txt increasing in size from 10 KB to 12 KB. Row A of information 200 shown in FIG. 2 illustrates information corresponding to at least one file (e.g., file1.txt) that changed state, or version, from time tₐ to time t_{b} corresponding to snapshot A and snapshot B, respectively. Row B shown in FIG. 2 illustrates a change of state, or version, of file2.txt wherein file2.txt was modified and resulted in an increase in size from 15 KB to 16 KB from snapshot B to snapshot C. Row C shown in FIG. 2 illustrates a change of state, or version, of file3.txt wherein file3.txt was deleted between time t_{c} corresponding to snapshot C and time t_{d} corresponding to snapshot D. Row D shown in FIG. 2 illustrates a change of state, or version, of file5.txt wherein file5.txt was created and first stored to, or added to, storage 130 between time t_{c} corresponding to snapshot C and time t_{d} corresponding to snapshot D. Row E shown in FIG. 2 illustrates a change of state, or version, of file1.txt wherein file1.txt was modified to result in an increase in size from 12 KB to 13 KB from snapshot D, corresponding to time t_{d}, to snapshot E, corresponding to time tₑ. Row F shown in FIG. 2 illustrates a change of state, or version, of file4.txt wherein file4.txt was modified to result in an increase in size from 25 KB to 27 KB from snapshot E, corresponding to time tₑ, to snapshot F, corresponding to time t_{f}.

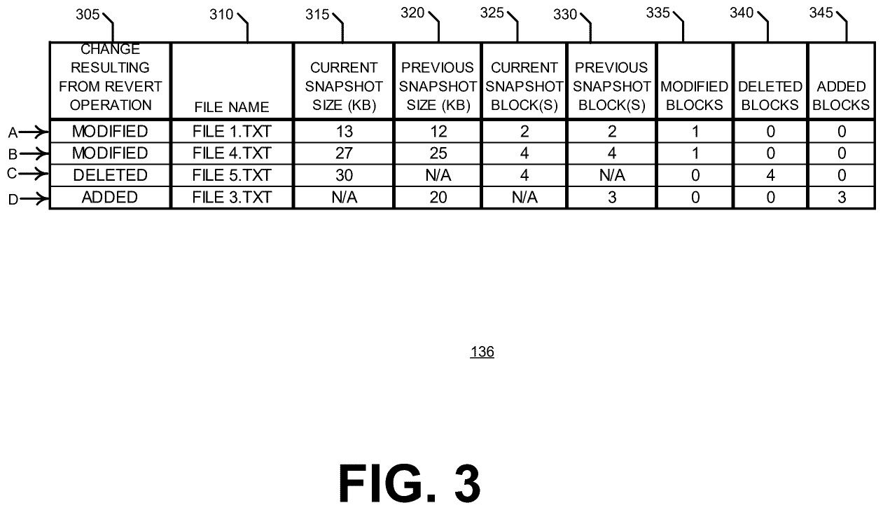

Turning now to FIG. 3, the figure illustrates information 136 that may be provided to user 140 who may be considering whether to initiate a reversion operation from a current state/version of a file to a previous state/version of a file. Continuing with the example described in reference to FIG. 2, if user 140 seeks to assess and determine effects of reverting files stored in the example directory from versions/states corresponding to snapshot E (changes or different resource state(s) shown in row E in FIG. 2) to versions/states corresponding to snapshot B (changes or different resource state(s) shown in row A in FIG. 2), information 136 shown in FIG. 3 may be provided to user 140, for example via user interface 110. Information 136 may be provided in response to at least one revert request to determine data that may be lost if a revert instruction is generated, or caused to be implemented. Thus, in response to at least one revert instruction, which may be generated based on, or in response to, information 136 shown in FIG. 3, file1.txt shown in field 310A would revert from current version size of 13 KB shown in field 315A to the smaller 12 KB version shown in field 320A, with one storage block of the two used to store file1.txt being modified as shown in field 335A, being revert to the previous version. File 4.txt would revert to the smaller 12 KB version with one storage block of the two used to store file 1.txt being modified as show in field 335B. As indicated by field 305C, reverting file states/versions corresponding to a current snapshot to states/versions corresponding to the previous snapshot, would result in file5.txt being lost, with the four blocks that are used to store file5.txt being deleted if the files were reverted to previous versions thereof as indicated by field 345C. As indicated by field 305D, reverting from a current snapshot to a previous snapshot would result in restoring file3.txt and the three storage blocks, indicated in field 345D, that store file3.txt. Accordingly, based on information 136 indicated by the embodiment shown in FIG. 3, before a revert action is performed, user 140 shown in FIG. 1 may determine that the benefit of reverting to a previous snapshot, (e.g., to snapshot B shown in FIG. 2) to recover the version of file1.txt corresponding thereto would outweigh the potential loss of file5.txt, which did not exist at the time corresponding to snapshot B being created and the user may cause the revert action to be taken. On the other hand, based on information indicted via user interface 110, as shown in FIG. 3, user 140 may assess the indicated information and determine that losing file5.txt would be more detrimental than not having the version of file1.txt corresponding to snapshot B and the user may determine not to perform the revert action to avoid losing file5.txt.

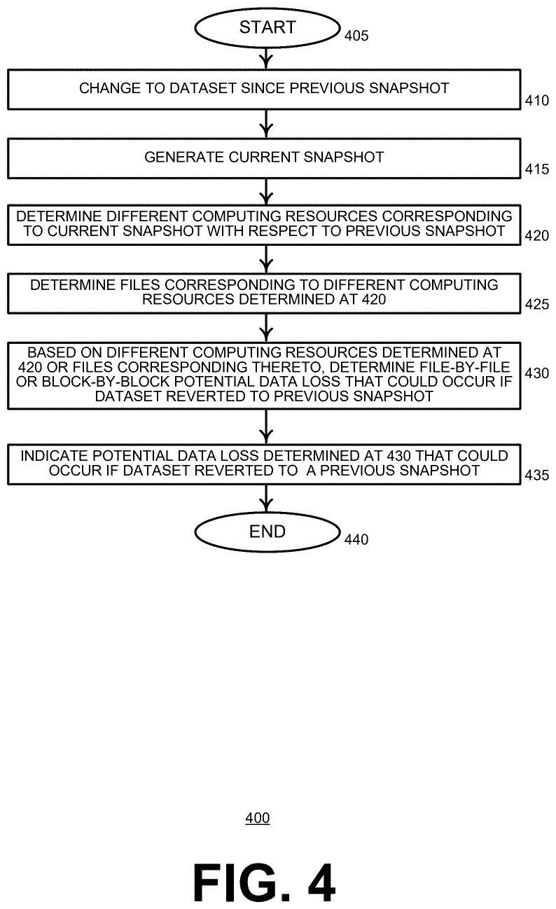

Turning now to FIG. 4, the figure illustrates a flow diagram of an example method 400 to provide information corresponding to computing resource changes that would result from performing at least one revert operation from a current state of at least one computing resource corresponding to a current snapshot to a previous version of the at least one computing resource to at least one previous version of the at least one computing resource corresponding to at least one previous snapshot. Method 400 begins at act 405. After a change to a data set or file system that occurs after a previous snapshot of the data set is generated at act 410, the computing system may generate at act 415 a new, or updated, snapshot corresponding to changes made to the data set. The new/updated snapshot may be referred to as a current snapshot. The data set may comprise at least one computing resource, such as, for example, at least one storage block or at least one file stored by a storage component such as storage device/component 130 illustrated in FIG. 1. The at least one computing resource may correspond to at least one file stored in an example directory by the storage device/component 130.

At act 420, the computing system may determine a change to the data set. The change determined by the computing system may be referred to as a determined different computing resource and may correspond to a current version/state of the at least one computing resource that corresponds to a current snapshot of the example directory being different than a previous version/state of the at least one computing resource that corresponds to a previous snapshot of the example directory. The computing system may determine the change to the data set in response to an input, or request, to the computing system. The input or request may be received via a user interface. The input/request may correspond to a user requesting/querying potential data loss if a rollback, or a revert operation, of at least one computing resource corresponding to the current snapshot to at least one previous version of the at least one computing resource corresponding to at least one previous snapshot were to be performed. In an example embodiment, the change to the data set may correspond to reverting during a single revert operations more than one computing resource corresponding to the current snapshot to more than one version/state corresponding to more than one previous snapshot.

At act 425, the computing system may determine files corresponding to different computing resources (e.g., the computing system may determine files corresponding to a current snapshot that may comprise versions of storage blocks that store information that has changed with respect to at least one previous snapshot) based on different computing resources determined at act 420. At act 430, the computing system may determine potential file-by-file or storage-block-by-storage-block data loss that could occur if at least one computing resource corresponding to the current snapshot is rolled back, or reverted, to at least one previous version of the at least one computing resource corresponding to at least one previous snapshot. The determining of the potential data loss may be based on different computing resources determined at act 420. At act 435, the computing system may indicate to a user via a user interface potential data loss determined at act 430 that could occur if the data set is reverted to at least one version of the data set corresponding to at least one previous snapshot as may have been requested by a user of the computing system. Accordingly, the computing system may provide information to a user of potential data loss that could occur with respect to at least one file if the computing system were to revert at least one of the at least one file to at least one previous version corresponding to at least one previous snapshot. Method 400 ends at act 440.

### Selective Retention During Revert Operation

Reverting to a previous snapshot may comprise a series of steps to facilitate a state of a file system being restored to a previous state. Providing an option for a user to choose and keep recent changes for certain files corresponding to a current snapshot while reverting other file(s) corresponding to state(s) corresponding to one or more previous snapshot(s) may result in additional steps with respect to snapshot revert operation(s) according to conventional techniques. Files to be reverted may be marked, flagged, or otherwise identified, and, for each file identified to be reverted, storage blocks used to store the current version of the file(s) may be backtracked by equipment corresponding to computing system 120 in reverse order through multiple previous snapshots until an identifier corresponding to a previous target snapshot is reached. If a user chooses to keep/port changes corresponding to certain files that exist with respect to a current snapshot if an older/previous snapshot is to be reverted to, the computing system 120 and user interface 110 may facilitate user 140 having capability to select certain files or exclude certain files corresponding to a newest/current snapshot, via, by, for example, selecting a file name, selecting a naming wildcard pattern, selecting a creation datetime range, selecting a file type, selecting a file ownership, and the like based on an assessment that may have resulted from the method described in reference to FIG. 4.

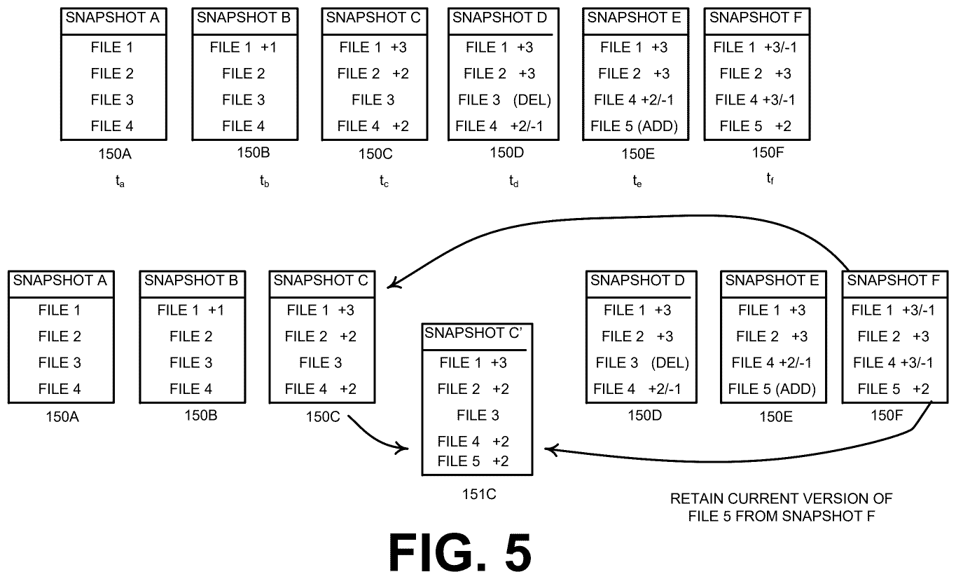

Turning now to FIG. 5, the figure illustrates multiple snapshots 150A, 150B, 150C, 150D, 150E, and 150F respectively corresponding to file set states of files of a file system stored on a storage device/component, such as storage component 130 illustrated in FIG. 1, at times tₐ, t_{b}, t_{c}, t_{d}, tₑ, and t_{f}. A user may desire to revert to snapshot 150C to recover a previous version of File 1, File 2, and File 4, the user may desire to recover File 3, which was deleted between t_{c} and t_{d}, and the user may desire not to lose File 5, which was added to the file set between t_{d} and tₑ. However, although reverting to snapshot C would result in reverting to the desired versions of files File 1, File 2, File 3, and File 4, reverting the file set to versions corresponding to snapshot C would result in losing File 5. Accordingly, a revert instruction may cause the computing system that may comprise, or that may be in communication with, the storage component that comprises the file set to revert to the version of File 5 corresponding to snapshot 150E, which is an earlier version of File 5 than a version corresponding to snapshot 150F, and to combine the reverted version of File5 corresponding to snapshot 150E with the versions of File 1, File 2, File 3, and File 4 corresponding to snapshot 150C into a modified snapshot 151C that comprises, or indicates, versions of files File 1, File 2, File 3, and File 4 corresponding to snapshot 150C and the version of File 5 corresponding to snapshot 150E. As shown in FIG. 5, modified snapshot 151C comprises a previous version of File 5 that was first reflected by intermediate snapshot 150E corresponding to time tₑ (e.g., temporally intermediate with respect to time t_{c} corresponding to previous snapshot 150C and time t_{f} corresponding to current snapshot 150F). Snapshot 151C is labeled as snapshot C′ in FIG. 5 to indicate that modified snapshot 151C primarily comprises, or indicates, versions of files File 1, File 2, File 3, and File 4 corresponding to snapshot 150C but also comprises, or indicates, a version of File 5 corresponding to snapshot 150E. Modified snapshot 151C may not correspond to a particular time because it may comprise information corresponding to multiple snapshots 150. Modified snapshot 151C may be referred to as a partial snapshot or a composite snapshot because the modified snapshot may comprise, or may be indicative of, a current version of a computing resource corresponding to a current snapshot or the modified snapshot may comprise a previous version of at least one other computing resource corresponding to at least one previous snapshot. Accordingly, user 140, illustrated in FIG. 1, may request a reversion from snapshot 150F to snapshot 150C but, according to method 400 described in reference to FIG. 4, may determine, or computing system 110 may determine, that the version of File 5 corresponding to snapshot 150E would be lost by reverting to snapshot 150C, and instead may determine, or computing system 110 may determine, to revert to a modified snapshot C′ that may be created by the computing system by reverting different files to different versions of the files corresponding to different snapshots, thus creating modified snapshot 151C based on the different versions of the files corresponding to the different snapshots. One or more of original snapshots 150A, 150B, 150C, 150D, 150E, and 150F may be retained by, or may be accessible by, the computing system along with modified snapshot 151C. Thus, File 1, File 2, File 3, and File 4 may be reverted to desired versions thereof corresponding to snapshot 150C and File 5 corresponding to snapshot 150E may be retained.

Upon, or after, reverting to modified snapshot 151C, thus restoring File 1, File 2, File 3, and File 4 to versions thereof corresponding to snapshot 150C and thus retaining the version of File 5 corresponding to snapshot 150E, the computing system may update metadata associated with versions of files corresponding to the modified snapshot 151C (e.g., metadata such as, for example, file inodes, file size, file timestamps, etc.) to result in modified snapshot metadata. The computing system may manage special files (e.g., update symbolic links or device files) corresponding to modified snapshot 151C. The computing system may update a journal (e.g., record the operation of reverting to modified snapshot 151C) to reflect the reverting to the modified snapshot. The computing system may flush changes or may ensure changes are written back to the disk (e.g., storage 130 shown in FIG. 1) corresponding to the reverting to the modified snapshot 151C. The computing system may unlock the filesystem and may validate the reverted state of files corresponding to target/modified snapshot 151C. The computing system may indicate, for example to a user or to another computing system or component, success in reverting to modified snapshot 151C.

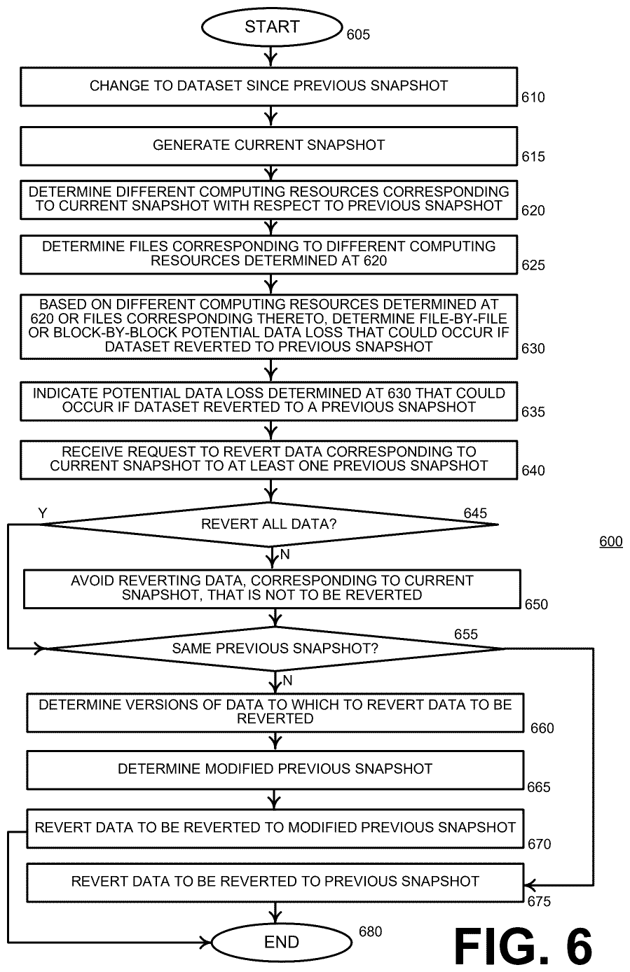

Turning now to FIG. 6, the figure illustrates a flow diagram of an example method 600 to provide information corresponding to computing resource changes that would result from performing at least one revert operation from a current state of at least one computing resource corresponding to a current snapshot to a previous version of the at least one computing resource to at least one previous version of the at least one computing resource corresponding to at least one previous snapshot. Method 600 begins at act 605. After a change to a data set that occurs after a previous snapshot of the data set is generated at act 610, the computing system may generate at act 615 a new, or updated, snapshot corresponding to the data set. The new/updated snapshot may be referred to as a current snapshot. The data set may comprise at least one computing resource, such as, for example, at least one storage block or at least one file stored by a storage component such as storage device/component 130 illustrated in FIG. 1. The at least one computing resource may correspond to storage of at least one file in an example directory by the storage device/component 130.

At act 620, the computing system may determine a change to the data set that would occur if a revert operation were to be performed. The change determined by the computing system may may be referred to as a determined different computing resource and may correspond to a current version/state of the at least one computing resource that corresponds to a current snapshot of the example directory being different than a previous version/state of the at least one computing resource that corresponds to a previous snapshot of the example directory. The computing system may determine the change to the data set in response to an input, or request, (e.g., a reversion query request), to the computing system, for example a request from a user, to revert to a previous snapshot. The input or request may be received via a user interface. The input/request may correspond to a user requesting a rollback, or requesting a revert operation, of at least one computing resource corresponding to the current snapshot to at least one previous version of the at least one computing resource corresponding to at least one previous snapshot. In an example embodiment, a determined change to the data set may correspond to reverting more than one computing resource corresponding to the current snapshot to more than one version/state corresponding to more than one previous snapshot.

At act 625, the computing system may determine files corresponding to different computing resources (e.g., the computing system may determine files corresponding to a current snapshot that may comprise versions of storage blocks that store information that has changed with respect to at least one previous snapshot) based on different computing resources determined at act 620. At act 630, the computing system may determine potential file-by-file or storage-block-by-storage-block data loss that could occur if at least one computing resource corresponding to the current snapshot is rolled back or reverted to at least one previous version of the at least one computing resource corresponding to at least one previous snapshot. The determining of the potential data loss may be based on different computing resources determined at act 620. At act 635, the computing system may indicate to a user via a user interface potential data loss determined at act 630 that could occur if the data set is reverted to at least one version of the data set corresponding to at least one previous snapshot as may have been requested by a user of the computing system. Accordingly, the computing system may provide information to a user of potential data loss that could occur with respect to at least one file if the computing system were to revert at least one of the at least one file to at least one previous version corresponding to at least one previous snapshot.

At act 640, the computing system may receive a revert request, or revert instruction, to revert data corresponding to a current snapshot to at least one previous snapshot. It will be appreciated that a revert request may comprise a request to revert files corresponding to a current snapshot to versions corresponding to more than one different previous snapshot. A revert request may be based on potential data loss information indicated at act 635. At act 645, a determination may be made whether the revert request comprises a request to revert all data corresponding to a current snapshot to at least one previous version corresponding to at least one previous snapshot. If a determination is made at act 645 that all data corresponding to a current snapshot is not to be reverted to at least one previous snapshot version, the computing system may, at act 650, mark, or flag, data corresponding to files that are not to be reverted such that reverting of the marked files may be avoided. Method 600 advances from act 650 to act 655. Returning to description of act 645, if a determination is made that a request/instruction received at act 640 is to revert all data corresponding to a current snapshot to versions corresponding to the previous snapshot, method 600 advances from act 645 to act 655.

At act 655, a determination is made whether all data to be reverted to at least one previous snapshot is to be reverted to the same previous snapshot. If a determination is made at act 655 that all data flagged, or marked, to be reverted is to be reverted to the same previous snapshot method 600 advances to act 675 and all data to be reverted is reverted to the same previous snapshot. Method 600 advances from act 675 to act 680 and ends. The previous snapshot to which data to be reverted is reverted at act 675 may comprise a previous snapshot or a modified previous snapshot as described in reference to FIG. 5.

Returning to description of act 655, if data marked, or flagged, to be reverted is not all to be reverted to the same previous snapshot, at act 660, the computing system may determine different versions of data corresponding to different snapshots to which data corresponding to a current snapshot is to be reverted. At act 665, the computing system may determine a modified previous snapshot that corresponds to versions of files associated with different previous snapshots. At act 670, the computing system may revert data to be reverted to a modified previous snapshot determined at act 665. Method 600 ends at act 680.

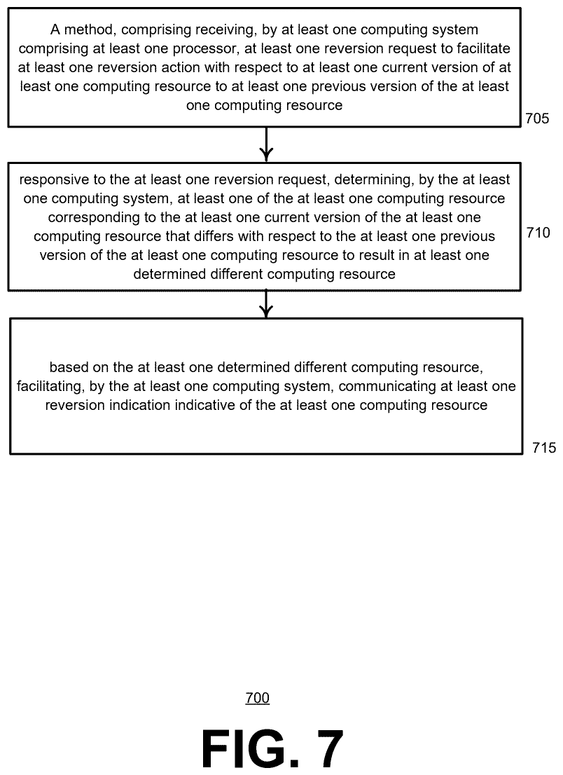

Turning now to FIG. 7, the figure illustrates a method 700, comprising at block 705 receiving, by at least one computing system comprising at least one processor, at least one reversion request to facilitate at least one reversion action with respect to at least one current version of at least one computing resource to at least one previous version of the at least one computing resource; at block 710 responsive to the at least one reversion request, determining, by the at least one computing system, at least one of the at least one computing resource corresponding to the at least one current version of the at least one computing resource that differs with respect to the at least one previous version of the at least one computing resource to result in at least one determined different computing resource; and at block 715 based on the at least one determined different computing resource, facilitating, by the at least one computing system, communicating at least one reversion indication indicative of the at least one computing resource.

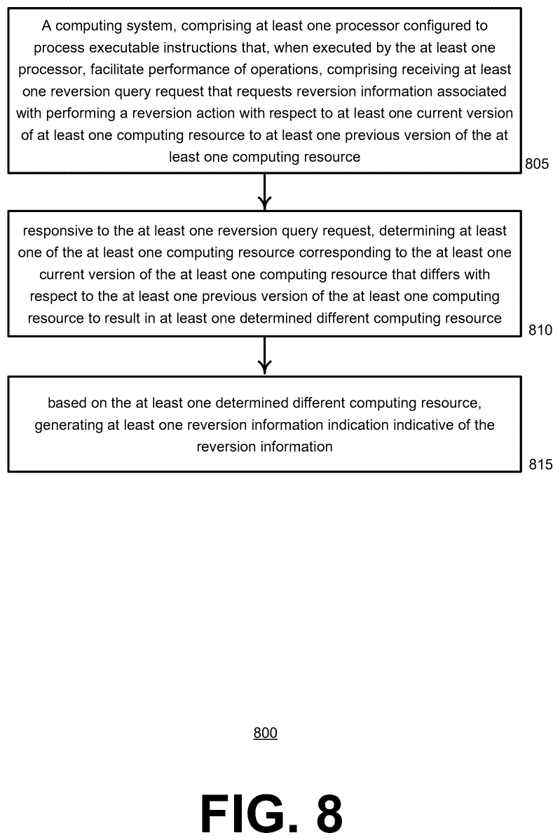

Turning now to FIG. 8, the figure illustrates a computing system 800, comprising block 805 at least one processor configured to process executable instructions that, when executed by the at least one processor, facilitate performance of operations, comprising receiving at least one reversion query request that requests reversion information associated with performing a reversion action with respect to at least one current version of at least one computing resource to at least one previous version of the at least one computing resource; at block 810 responsive to the at least one reversion query request, determining at least one of the at least one computing resource corresponding to the at least one current version of the at least one computing resource that differs with respect to the at least one previous version of the at least one computing resource to result in at least one determined different computing resource; and at block 815 based on the at least one determined different computing resource, generating at least one reversion information indication indicative of the reversion information.

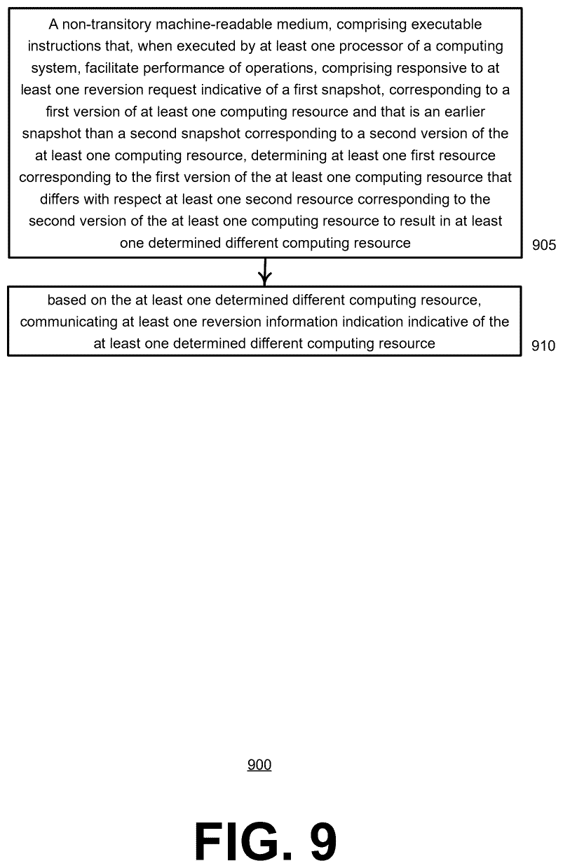

Turning now to FIG. 9, the figure illustrates non-transitory machine-readable medium 900, comprising at block 905 executable instructions that, when executed by at least one processor of a computing system, facilitate performance of operations, comprising, responsive to at least one reversion request indicative of a first snapshot, corresponding to a first version of at least one computing resource and that is an earlier snapshot than a second snapshot corresponding to a second version of the at least one computing resource, determining at least one first resource corresponding to the first version of the at least one computing resource that differs with respect at least one second resource corresponding to the second version of the at least one computing resource to result in at least one determined different computing resource; and at block 910, based on the at least one determined different computing resource, communicating at least one reversion information indication indicative of the at least one determined different computing resource.

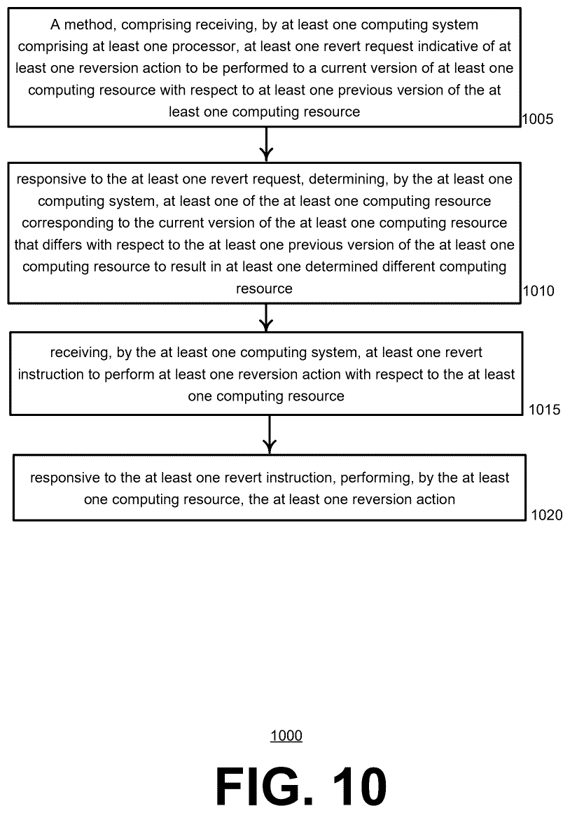

Turning now to FIG. 10, the figure illustrates a method 1000, comprising at block 1005 receiving, by at least one computing system comprising at least one processor, at least one revert request indicative of at least one reversion action to be performed to a current version of at least one computing resource with respect to at least one previous version of the at least one computing resource; at block 1010, responsive to the at least one revert request, determining, by the at least one computing system, at least one of the at least one computing resource corresponding to the current version of the at least one computing resource that differs with respect to the at least one previous version of the at least one computing resource to result in at least one determined different computing resource; at block 1015 receiving, by the at least one computing system, at least one revert instruction to perform at least one reversion action with respect to the at least one computing resource; and at block 1020 responsive to the at least one revert instruction, performing, by the at least one computing resource, the at least one reversion action.

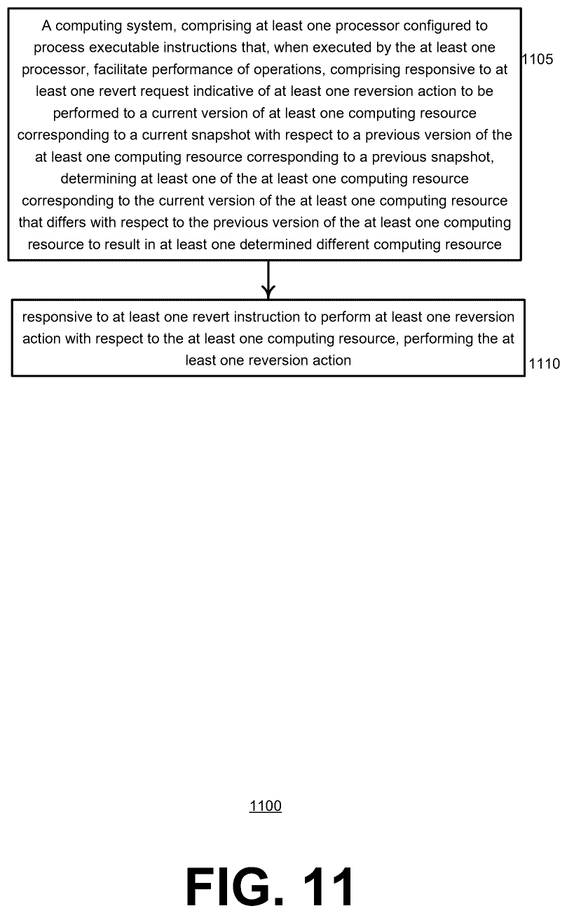

Turning now to FIG. 11, the figure illustrates a computing system 1100, comprising at block 1105 at least one processor configured to process executable instructions that, when executed by the at least one processor, facilitate performance of operations, comprising, responsive to at least one revert request indicative of at least one reversion action to be performed to a current version of at least one computing resource corresponding to a current snapshot with respect to a previous version of the at least one computing resource corresponding to a previous snapshot, determining at least one of the at least one computing resource corresponding to the current version of the at least one computing resource that differs with respect to the previous version of the at least one computing resource to result in at least one determined different computing resource; and at block 1110 responsive to at least one revert instruction to perform at least one reversion action with respect to the at least one computing resource, performing the at least one reversion action.

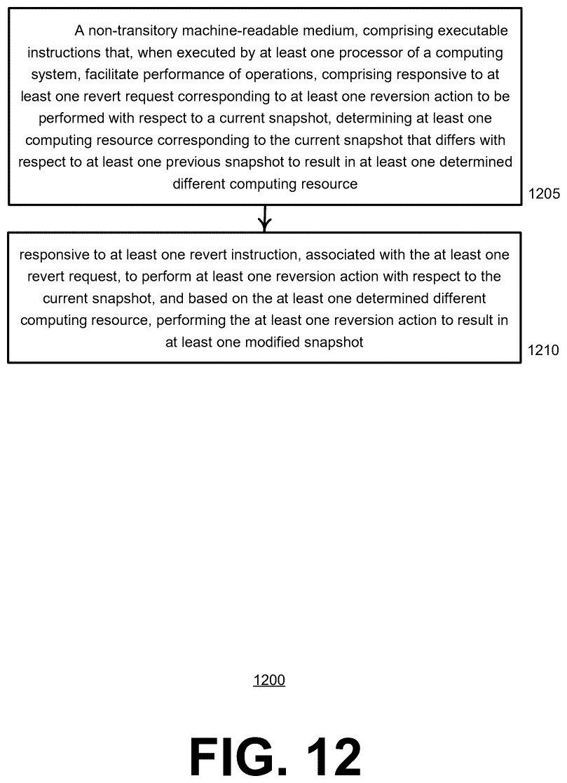

Turning now to FIG. 12, the figure illustrates non-transitory machine-readable medium 1200, comprising at block 1205 executable instructions that, when executed by at least one processor of a computing system, facilitate performance of operations, comprising, responsive to at least one revert request corresponding to at least one reversion action to be performed with respect to a current snapshot, determining at least one computing resource corresponding to the current snapshot that differs with respect to at least one previous snapshot to result in at least one determined different computing resource; and at block 1210 responsive to at least one revert instruction, associated with the at least one revert request, to perform at least one reversion action with respect to the current snapshot, and based on the at least one determined different computing resource, performing the at least one reversion action to result in at least one modified snapshot.

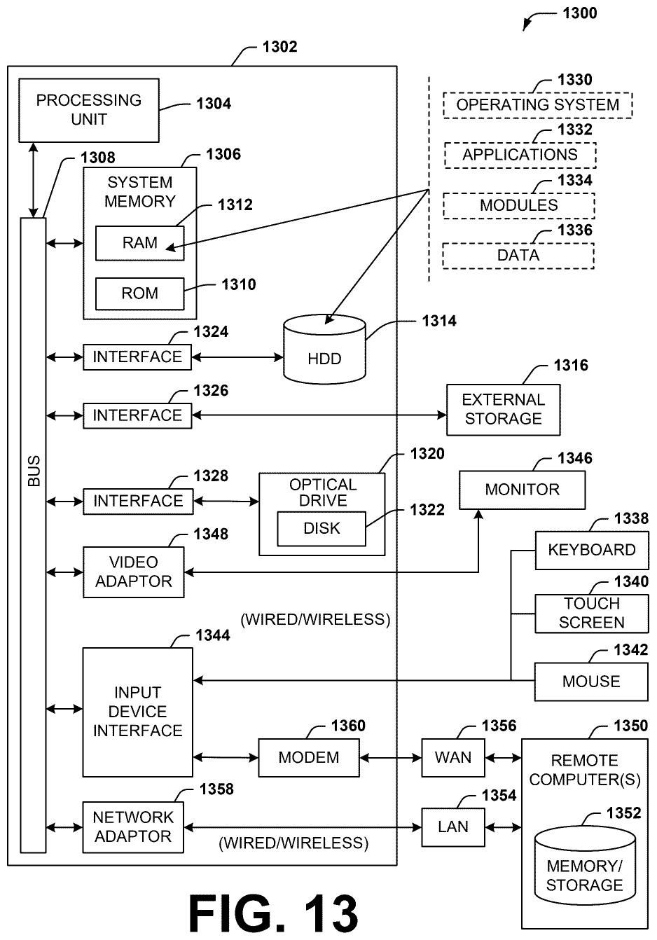

In order to provide additional context for various embodiments described herein, FIG. 13 and the following discussion are intended to provide a brief, general description of a suitable computing environment 1300 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 13, the example environment 1300 for implementing various embodiments of the aspects described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors and may include a cache memory. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1313 and RAM 1312. A basic input/output system (BIOS) can be stored in a non-volatile memory such as ROM, erasable programmable read only memory (EPROM), EEPROM, which BIOS contains the basic routines that help to transfer information between elements within the computer 1302, such as during startup. The RAM 612 can also include a high-speed RAM such as static RAM for caching data.

Computer 1302 further includes an internal hard disk drive (HDD) 1314 (e.g., EIDE, SATA), one or more external storage devices 1316 (e.g., a magnetic floppy disk drive (FDD) 1316, a memory stick or flash drive reader, a memory card reader, etc.) and an optical disk drive 1320 (e.g., which can read or write from a CD-ROM disc, a DVD, a BD, etc.). While the internal HDD 1314 is illustrated as located within the computer 1302, the internal HDD 1314 can also be configured for external use in a suitable chassis (not shown). Additionally, while not shown in environment 1300, a solid-state drive (SSD) could be used in addition to, or in place of, an HDD 1314. The HDD 1314, external storage device(s) 1316 and optical disk drive 1320 can be connected to the system bus 1308 by an HDD interface 1324, an external storage interface 1326 and an optical drive interface 1328, respectively. The interface 1324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the . NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can comprise a security module, such as a trusted processing module (TPM). For instance, with a TPM, boot components hash next in time boot components, and wait for a match of results to secured values, before loading a next boot component. This process can take place at any layer in the code execution stack of computer 602, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can be also connected to the system bus 608 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are example and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by at least one computing system comprising at least one processor, at least one reversion request to facilitate at least one reversion action with respect to at least one current version of at least one computing resource to at least one previous version of the at least one computing resource;
responsive to the at least one reversion request, determining, by the at least one computing system, at least one of the at least one computing resource corresponding to the at least one current version of the at least one computing resource that differs with respect to the at least one previous version of the at least one computing resource to result in at least one determined different computing resource; and
based on the at least one determined different computing resource, facilitating, by the at least one computing system, communicating at least one reversion indication indicative of the at least one computing resource.

2. The method of claim 1, wherein the at least one computing resource comprises at least one storage unit, and wherein the at least one determined different computing resource comprises at least one determined different storage unit.

3. The method of claim 2, wherein the at least one storage unit comprises at least of: at least one file, at least one folder, or at least one volume.

4. The method of claim 2, wherein the at least one determined different storage unit comprises at least one determined different storage block.

5. The method of claim 4, wherein the determining of the at least one determined different computing resource comprises:
determining at least one file corresponding to the at least one determined different storage block to result in at least one determined file.

6. The method of claim 5, wherein the at least one reversion indication is indicative of the at least one determined file.

7. The method of claim 6, wherein the at least one reversion indication is indicative that the at least one current version of the at least one determined file is threshold likely to be lost in response to the at least one current version of the at least one determined file being reverted to the at least one previous version of the at least one determined file.

8. The method of claim 1, wherein the at least one determined different computing resource is determined within a kernel space of a memory corresponding to the at least one computing system.

9. The method of claim 1, wherein the determining of the at least one determined different computing resource comprises determining, in a reverse temporal order with respect to which the at least one current version of the at least one computing resource and the at least one previous version of the at least one computing resource were created, at least one intervening version of the at least one computing resource.

10. The method of claim 1, wherein at least one of the at least one current version of the at least one computing resource, at least one intervening version of the at least one computing resource, or the at least one previous version of the at least one computing resource corresponds to at least one snapshot.

11. The method of claim 10, wherein the at least one determined different computing resource is associated with metadata that corresponds to the at least one current version of the at least one computing resource, the at least one intervening version of the at least one computing resource, or the at least one previous version of the at least one computing resource.

12. The method of claim 10, wherein the at least one determined different computing resource is based on the at least one current version of the at least one computing resource, the at least one intervening version of the at least one computing resource, or the at least one previous version of the at least one computing resource.

13. A computing system, comprising at least one processor configured to process executable instructions that, when executed by the at least one processor, facilitate performance of operations, comprising:
receiving at least one reversion query request that requests reversion information associated with performing a reversion action with respect to at least one current version of at least one computing resource to at least one previous version of the at least one computing resource;
responsive to the at least one reversion query request, determining at least one of the at least one computing resource corresponding to the at least one current version of the at least one computing resource that differs with respect to the at least one previous version of the at least one computing resource to result in at least one determined different computing resource; and
based on the at least one determined different computing resource, generating at least one reversion information indication indicative of the reversion information.

14. The computing system of claim 13, wherein the at least one previous version of the at least one computing resource comprises at least one earliest version and at least one intermediate version, wherein the at least one earliest version corresponds to at least one earliest time, wherein the at least one current version of the at least one computing resource corresponds to at least one current time, wherein the at least one intermediate version corresponds to at least one intermediate time that is later than the at least one earliest time and earlier than the at least one current time, and wherein the reversion information corresponds to at least one of the at least one earliest version or at least one of the at least one intermediate version.

15. The computing system of claim 14, wherein the operations further comprise:
responsive to the at least one reversion information indication, receiving at least one reversion request to facilitate a reversion action with respect to the at least one current version of at least one computing resource to at least one of the at least one previous version of the at least one computing resource.

16. The computing system of claim 15, wherein the at least one computing resource comprises at least one file, and wherein the at least one reversion information indication is indicative of at least one change to at least one storage block corresponding to the at least one computing resource to be caused by the reversion action.

17. A non-transitory machine-readable medium, comprising executable instructions that, when executed by at least one processor of a computing system, facilitate performance of operations, comprising:
responsive to at least one reversion request indicative of a first snapshot, corresponding to a first version of at least one computing resource and that is an earlier snapshot than a second snapshot corresponding to a second version of the at least one computing resource, determining at least one first resource corresponding to the first version of the at least one computing resource that differs with respect at least one second resource corresponding to the second version of the at least one computing resource to result in at least one determined different computing resource; and
based on the at least one determined different computing resource, communicating at least one reversion information indication indicative of the at least one determined different computing resource.

18. The non-transitory machine-readable medium of claim 17, wherein the at least one reversion information indication is indicative of stored information stored in at least one storage unit corresponding to the second snapshot to be lost as a result of the second version of the at least one computing resource being reverted to the first version of the at least one computing resource.

19. The non-transitory machine-readable medium of claim 17, wherein the at least one reversion information indication is indicative of at least one file corresponding to the second version that differs with respect to the first version.

20. The non-transitory machine-readable medium of claim 17, wherein the at least one determined different computing resource is determined based on first metadata corresponding to the first version and second metadata corresponding to the second version.
